(19) United States
(12) Patent Application Publication
(10) Pub. No.: US 2019/0023189 A1
(43) Pub. Date: Jan. 24, 2019

(54) COLLAPSIBLE ROD AND JOINT STRUCTURE TO COUPLE WITH VARIOUS EXISTING ATVs

(71) Applicant: DAN MICHAEL PERKINS, CUSTER PARK, IL (US)

(72) Inventor: DAN MICHAEL PERKINS, CUSTER PARK, IL (US)

(21) Appl. No.: 15/652,273

(22) Filed: Jul. 18, 2017

(51) Int. Cl. B60R 9/00; B60J 7/10

(52) U.S. Cl. CPC B60R 9/00; B60J 7/102

(57) ABSTRACT

The present invention relates to a cargo rack enabled to get installed on an all-terrain vehicle (ATV) for providing an increased amount of cargo that an ATV can carry quickly and easily, by simply sliding the cargo rack into place. The cargo rack herein comprises a sleeve section integrally housed onto an at least one end portion of an ATV frame structure, wherein the sleeve section is further enabled to receive a collapsible U-shaped extension section made up of plurality of hollow tubes, wherein each of the plurality of hollow tubes has a longitudinal pocket enabled to receive yet another hollow tube which further enables providing a collapsible U-shaped extension section.

### FIELD OF THE INVENTION

The present invention relates to a cargo rack enabled to be installed on an all-terrain vehicle (ATV) for providing an increased amount of cargo that an ATV can carry quickly and easily, by simply sliding the cargo rack into place.

### BACKGROUND OF THE INVENTION

All-terrain vehicles (ATV) are used in activities such as camping, hiking, and other outdoor activities. Conventionally, ATV designs are relatively standard and include passenger areas such as seating and cargo racks. A widespread problem which exists, however, with the cargos rack of ATVs is a lack of options to expand the available cargo space from beyond what is given. In cases, wherein it is desired to carry a passenger and additional cargo, a user may be unable to accomplish the same.

Further, the various cargo rack attached ATV designs now available only provide solution to coupling these cargo racks onto the ATV but fails compelling the idea of a collapsible rack structure made up of plurality of rods, wherein at the time the cargo racks are of no use it can't be folded and made easily carriable. Also, there remains an unaddressed problem of taking these ATV with coupled cargo racks onto the places where there exists less space for various vehicle to pass through, therefore cannot support heavily loaded and more space consuming ATV's with loaded cargo.

Changing weather for various travelers carrying cargos on their ATV is also a huge problem. Any storage inside the cargo requires protection from the outside environment and further there don't exist an idea of providing plurality of rack system arranged in parallel to each other for supporting the plurality of cargos on the top of every cargo which further enables occupying less space and helps increasing the balancing part of the various ATV carrying cargo.

Prior art with publication number (US9168875B2) defines a quick release ATV rack system for allowing a user to selectively increase the amount of cargo storage space on an ATV without removal of passenger seating with a removable rack. The quick release ATV rack system comprises a base frame and a two pairs of fastener assemblies. The base frame is defined by a top tier and a bottom tier and additionally includes a proximal end configured to attach to a factory ATV rack and a distal end having an elevated backstop. The top tier provides the primary support structure and an attaching structure embodied as a pair of top fastener assemblies. The bottom tier provides an additional stabilizing aspect in the form of a pair of bottom fastener assemblies which assists the quick release ATV rack system in fastening to the factory rack on an ATV.

Prior art with application number (EP20100183779) defines an interchangeable load-carrying system is intended for use with an all-terrain vehicle (ATV) having a vehicle frame and a driver seat, and the system includes a receiver fixed to the vehicle frame adjacent the rear of the driver seat; a first load-carrying frame with a first engagement member configured for selective engagement with the receiver; a second load-carrier frame with a second engagement member configured for selective engagement with the receiver; and a coupler securable between the receiver and one of the first and second load-carrier frames for selectively locking and releasing of one of these frames from the receiver.

Prior art with application number (US09756341) defines a hauling vehicle equipped with a conventional receiving style hitch assembly having a tubular cross member extended along the width of the hauling vehicle and attached to the frame thereof. The tubular cross member includes opposing ends and a centrally located extension tube each having an opening for receiving the mounting hardware of the carrier rack. The carrier rack further comprises a sturdily constructed carrying platform, ramp means for loading the carrying platform, and retractable casters for supporting the carrier rack when not mounted on a hauling vehicle. In addition, the carrier rack preferably has one or more rear safety lights which are communicatively connected to the electrical system of the vehicle via a wiring harness. For the driver to easily locate the rear of the carrier rack via a rear-view mirror, a removable tailgate may also be installed.

Therefore, there remains a need to overcome above mentioned problems and our invention resolve this entire problem.

### SUMMARY OF THE INVENTION

In order to overcome the various difficulties of the prior art the present invention provides a cargo rack enabled to be installed on an all-terrain vehicle (ATV), wherein the cargo rack further comprises: a sleeve section integrally housed onto an at least one end portion of an ATV frame structure, wherein the sleeve section is further enabled to receive a collapsible U-shaped extension section made up of plurality of hollow tubes, wherein each of the plurality of hollow tubes has a longitudinal pocket enabled to receive yet another hollow tube which further enables providing a collapsible U-shaped extension section.

Also the cargo rack has at least one groove present on the sleeve section and on the plurality of hollow tubes, wherein each groove among the plurality of grooves is enabled to receive at least one vertical extension mean for coupling a cover member to cover a cargo loaded onto the ATV.

Further, the cargo rack comprises at least one rack member enabled to get attached to at least one vertical extension mean parallel to the cargo rack coupled at a back of the ATV.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates a perspective view in accordance with an embodiment of the system.

FIG. 2 illustrates other perspective view in accordance with one embodiment of the system.

FIG. 3 illustrates another perspective view in accordance with one embodiment of the system.

### DETAIL DESCRIPTION OF THE INVENTION:

Reference will now be made in detail to the exemplary embodiment(s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

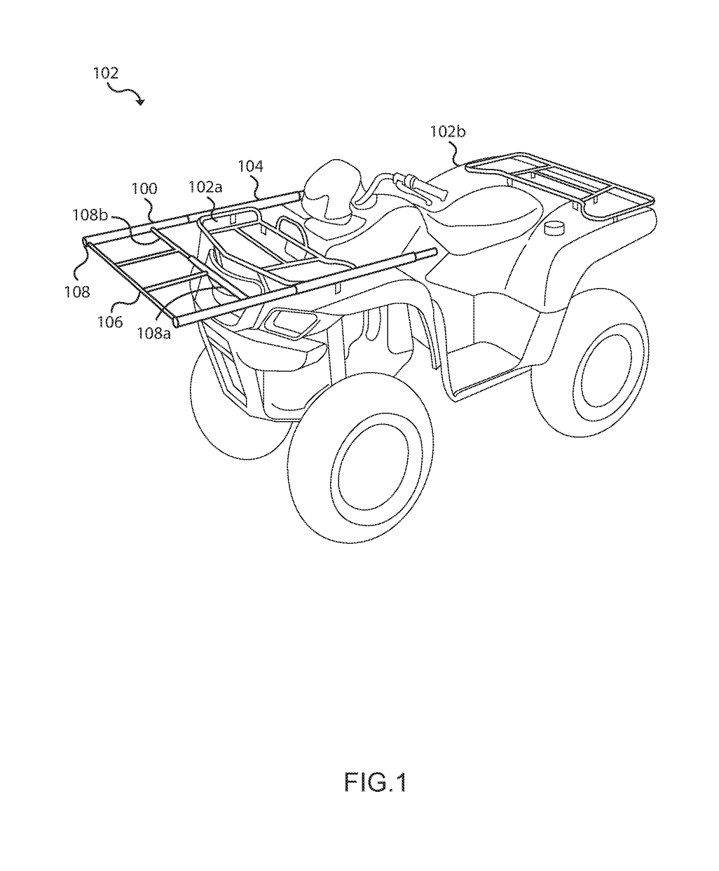

FIG. 1 illustrates a cargo rack [100] enabled to be installed on an all-terrain vehicle (ATV) [102], wherein the cargo rack [100] comprises: a sleeve section [104] integrally housed onto an at least one end portion [102a & 102b] of the ATV [102], wherein the sleeve section [104] is further enabled to receive a collapsible U-shaped extension section [106] made up of plurality of hollow tubes [108], wherein each of the plurality of hollow tubes [108] has a longitudinal pocket [108a] to receive yet another hollow tube [108b] among the plurality of hollow tubes [108]. The cargo rack [100] discussed herein is normally enabled to get installed either behind the seat or to the front of the driver on the ATV, wherein the cargo rack [100] is further enabled to get either bolted, welded or any combination thereof onto the body or on the frame of the ATV. The cargo rack [100] further is made up of material which is flexible or solid in nature, wherein the various material type used for the construction of the cargo rack [100] includes at least one of a metal, rubber, a fiber, a polyester or any combination thereof. The cargo rack [100] include a sleeve section [104] integrally been housed to body or to the frame of the ATV [102]. The sleeve section [104] herein is enabled to get installed either at the back or to the front of an ATV [102]. The sleeve section [104] herein, is likely a hollow cylindrical rod providing free end movement of the collapsible U-shaped extension section [106] inside or outside from both of its open end. Moreover, the collapsible U-shaped extension section [106] is made up of plurality of hollow tubes [108]. The plurality of hollow tubes [108] herein is enabled to receive another rod into its longitudinal pocket [108a] having parallel axis and therefore, enables providing a collapsible and foldable U-shaped extension section [106]. The received each of the hollow tubes [108] into the longitudinal pocket [108a] features a wingnut or other mechanism to tighten the coupling of the plurality of hollow tubes [108]. As collapsible U-shaped extension section [106] is made up of plurality of hollow tubes [108] at times the at least one user requires adjusting the width of the cargo rack [100] coupled to the front side or at the back of the ATV [102], the at least one user is enabled to cut short the width of the cargo rack [100] either manually or automatically by simply allowing yet another hollow tube [108b] to get received inside the longitudinal pocket [108a] of the plurality of hollow tubes [108]. The plurality of hollow tubes [108] is enabled to either integrally coupled to the sleeve section [104] or is enabled to removable-ly coupled to the sleeve section [104]. The collapsible U-shaped extension section [106] is therefore either enabled to get folded along its vertical axis or is enabled to get folded along its horizontal axis and therefore enables providing the at least one user using the cargo rack [100] a flexibility of easy carrying, folding, holding, and storing the entire structure into less occupied space.

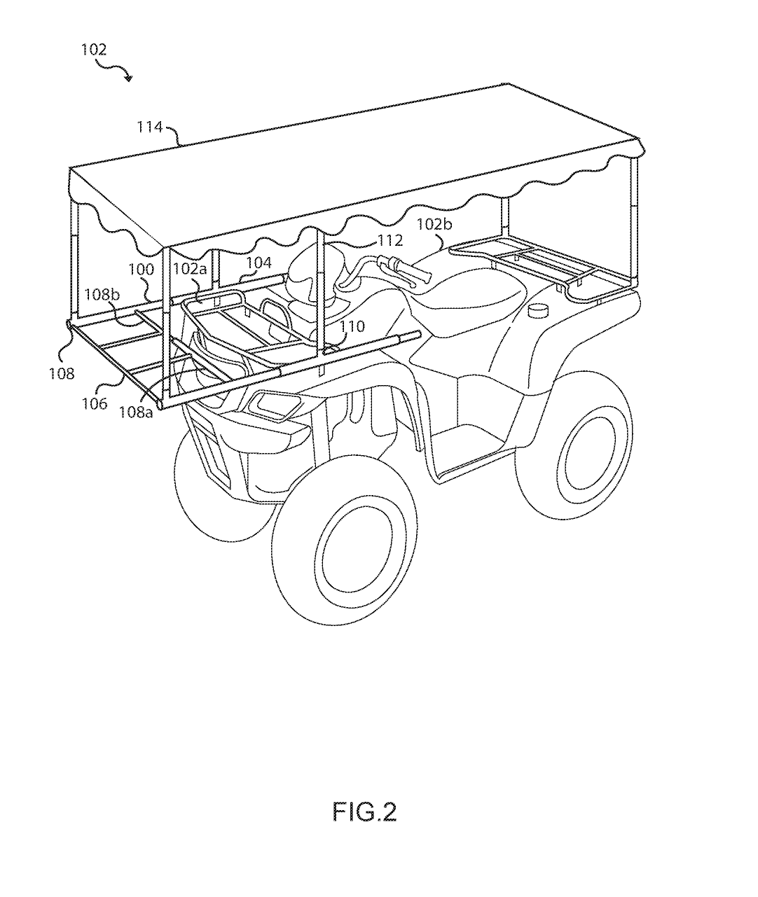

FIG. 2 illustrates a cargo rack [100] enabled to be installed on an all-terrain vehicle (ATV) [102] comprises: a sleeve section [104] integrally housed onto an at least one end portion [102a & 102b] of an ATV [102], wherein the sleeve section [104] is further enabled to receive a collapsible U-shaped extension section [106] made up of plurality of hollow tubes [108], wherein each of the plurality of hollow tubes [108] has a longitudinal pocket [108a], to receive yet another hollow tube [108b] among the plurality of hollow tubes [108]; and at least one groove [110] present on the sleeve section [104] and on the plurality of hollow tubes [108], wherein the each groove [110] among plurality of grooves is enabled to receive at least one vertical extension mean [112] for coupling a cover member [114] to cover a cargo loaded onto the ATV [102]. The at least one vertical extension mean [112] is further made up of plurality of small sections which is enabled to get folded or get unfolded to increase or decrease the length of the at least one vertical extension mean [112]. The at least one vertical extension mean [112] is further provided with an attachment member [not shown], wherein the attachment member couples to the cover member [114] at the rear end portion of the at least one vertical extension mean [112]. Herein, the attachment member is either one of the following a Velcro holder, a o ring, a button or any combination thereof. The mentioned cover member [114] further is enabled to cover either one of the loaded cargo onto the ATV [102] or the entire ATV [102] giving the ATV [102] a look alike to a car and therefore protecting the driver or the cargo from any weather damage. In case the length of each of the cargo is big the at least one user is enabled to adjust the length of the at least one vertical extension mean [112] and further enabling coupling of the cover member [114] onto the at least one vertical extension mean [112]. Further, the cover member [114] is made up of highly stretchable material and synthetic material which is enabled to stretch for any length or width of the cargo or the ATV [102].

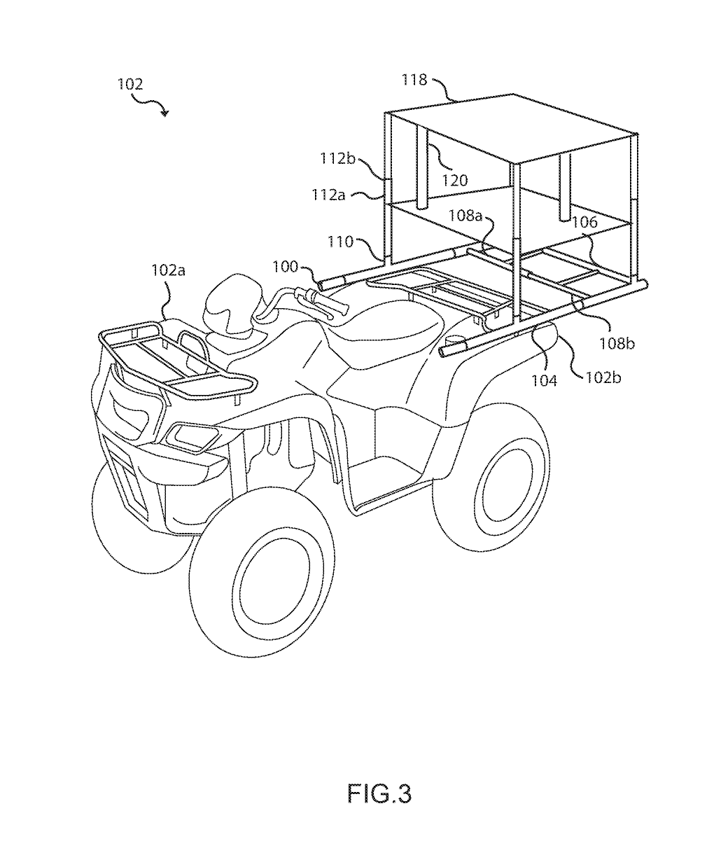

FIG. 3 illustrates a cargo rack [100] enabled to be installed on an all-terrain vehicle (ATV) [102] comprising: a sleeve section [104] integrally housed onto an at least one end portion [102a & 102b] of an ATV [102], wherein the sleeve section [104] is further enabled to receive a collapsible U-shaped extension section [106] made up of plurality of hollow tubes [108]. The plurality of hollow tubes [108] has longitudinal pocket [108a] which are enabled to receive yet another hollow tube [108b] among the plurality of hollow tubes [108]. Also, cargo rack [100] comprises at least one groove [110] present on the sleeve section [104] and on the plurality of hollow tubes [108], wherein each groove [110] among plurality of grooves is enabled to receive at least one vertical extension mean [112] which is further made up of plurality of small sections [112a] to get folded or get unfolded for adjusting the length of the at least one vertical extension mean [112]. Herein, at least one vertical extension mean [112] also comprises at least one rack member [118] enabled to get coupled to at least one opening [112b] present on the plurality of small sections [112a] of the at least one vertical extension mean [112]. The at least one rack member [118] is stacked parallel to the cargo rack [100] coupled at a back of the ATV [102]. The at least one rack member [118] provides more space for loading more number of cargos onto the cargo rack [100] coupled to an ATV [102]. Herein, the vertical extension mean [112] mainly supports a rectangular or a square shape of rack member [118] having horizontal support bars [118] in between to support heavy cargos and prevent them from falling in route. The arrangement of the cargo rack [100] with a rack member [118] attachment is enabled to be coupled at the back of the ATV [102] which do not block the line of site for the driver and enables the driver to drive the ATV [102] safely without a distraction.

In the preferred embodiment the at least one user is enabled to make a fitting or coupling of the sleeve section [104] onto the frame or onto the body of the ATV [102], wherein the sleeve section [104] herein is like a hollow tube open at both the end enabled to receive a collapsible U-shaped extension section [106] made up of plurality of hollow tubes [108], wherein each of the plurality of hollow tubes [109] has a longitudinal pocket [108a], wherein each of the longitudinal pocket [108a] is enabled to receive yet another hollow tube [108b] among the plurality of the hollow tubes [108]. Once the sleeve section [104] is fitted onto the frame or onto the body of the ATV [102] the at least one user is enabled to carry increased number of cargos lifted by the collapsible U-shaped extension section [106]. Further, if the cargo size is too big to fit into the collapsible U-shaped extension section [106] the at least one user is enabled to adjust the length of the collapsible U-shaped extension section [106] either manually or automatically by simply extending the length of the plurality of hollow tubes [108] of which the collapsible U-shaped extension section [106] is made up of. The at least one user herein, is enabled to increase the length or the width of the hollow tubes [108] and finally of the collapsible U-shaped extension section [106] automatically, by simply accessing the remote-control device provided with the ATV [102]. The remote-control device herein is any smart device or any electronic device, electronically coupled to the ATV [102]. These entire cargo rack [100] herein is made up of a solid material which is light weighted and corrosion resistant which enables providing a cargo rack [100] adaptable for all weather type and is weather protected.

In other embodiment the at least one user at least is enabled to couple a cover member [114] to cover a cargo loaded onto the ATV [102]. The at least one user herein is enabled to couple a cover member [114] with the help of the at least one vertical extension mean [112]. The at least one vertical extension mean [112] is coupled to the sleeve section [104] and to the plurality of hollow tubes [108] by the at least one groove [110]. Herein, the at least one user when reorganizes the need of the coupling a cover member [114] to the ATV [102] or to the collapsible U- shaped extension section [106] in order to provide protection either to the driver or to the loaded cargo the at least one user is enabled to fit the at least one vertical extension mean [112] to the at-least one groove [110] provided at sleeve section [104] and on the plurality of hollow tubes and is further enabled to attach the cover member [114] to at least one vertical extension mean [112] rested on at least one groove [110]. Also, the at least one user is provided with the freedom to adjust the height of the at least one vertical extension mean [112] in order to provide increased or decreased length of the at least one vertical extension mean [112]. The at least one vertical extension mean [112] is further made up of plurality of small section [112a] which enables the at least one user to increase or decrease the length of the at least one vertical extension mean [112] to attach a cover member [114].

In yet another embodiment the cargo rack [100] is coupled to the at least one rack member [118] is enabled to get coupled to at least one vertical extension mean [112] parallel to the cargo rack [100] coupled at the back of the ATV [102]. The at least one rack member [118] is enabled to get coupled to at least one opening [112b] present on the plurality of small sections [112a] of the at least one vertical extension mean [112] coupled parallel to the collapsible U-shaped extension section [106] but at the back of the ATV [102]. The at least one rack member [118] herein is enabled to carry increased number of cargos onto the same ATV [102] and therefore enables solving the various space related problem for the increased number of the cargo.

What is claimed is:

1. A cargo rack enabled to be installed on an all-terrain vehicle (ATV) comprises:
a sleeve section integrally housed onto an at least one end portion of the ATV, wherein the sleeve section is further enabled to receive a collapsible U-shaped extension section made up of a plurality of hollow tubes, wherein each of the hollow tube has a longitudinal pocket enabled to receive yet another hollow tube.

2. The cargo rack in claim 1; wherein each of the sleeve section and the plurality of hollow tube further comprises at least one groove, wherein at least one groove is enabled to receive at least one vertical extension mean for coupling a cover member to cover a cargo loaded onto the cargo rack.

3. The cargo rack in claim 2; wherein the at least one vertical extension mean is enabled to receive at least one rack member, parallel to the at least one collapsible U-shaped extension section coupled at a back of the ATV.

4. The cargo rack in claim 1; wherein the hollow tubes into the longitudinal pocket features a wingnut or other mechanism to tighten the coupling of the plurality of hollow tubes.

5. The cargo rack in claim 1; wherein a length and a width of the cargo rack is adjusted automatically by an at least one user.

6. The cargo rack in claim 5; wherein a remote-control device enables the automatic adjustment of the length and width of the cargo rack.

7. A cargo rack enabled to be installed on an all-terrain vehicle (ATV) comprises:
a. a sleeve section integrally housed onto an at least one end portion of an ATV, wherein the sleeve section is further enabled to receive a collapsible U-shaped extension section made up of a plurality of hollow tubes, wherein each of the hollow tubes has a longitudinal pocket enabled to receive yet another hollow tube; and
b. at least one groove present on each of the sleeve section and on the plurality of hollow tubes, wherein at least one groove of each of the sleeve section and of the plurality of hollow tubes is enabled to receive at least one vertical extension mean for coupling a cover member to cover a cargo loaded onto the ATV.

8. The cargo rack in claim 7; wherein the at least vertical extension mean is further made up of a plurality of small section which enables an at least one user to increase or decrease the length of the at least one vertical extension mean.

9. The cargo rack in claim 7; wherein the at least one vertical extension mean is enabled to receive at least one rack member, parallel to the at least one collapsible U-shaped extension section coupled at a back of the ATV.

10. The cargo rack in claim 7; wherein the hollow tubes into the longitudinal pocket features a wingnut or other mechanism to tighten the coupling of the plurality of hollow tubes.

11. The cargo rack in claim 7; wherein an at least one user is enabled to adjust the length and width of the cargo rack automatically.

12. The cargo rack in claim 11; wherein a remote-control device enables the automatic adjustment of the length and width of the cargo rack.

13. A cargo rack enabled to be installed on an all-terrain vehicle (ATV) comprises:
a. a sleeve section integrally housed onto an at least one end portion of an ATV, wherein the sleeve section is further enabled to receive a collapsible U-shaped extension section made up of a plurality of hollow tubes, wherein each of the plurality of hollow tube has a longitudinal pocket enabled to receive yet another hollow tube;
b. at least one groove present on each of the sleeve section and on the plurality of hollow tubes, wherein at least one groove of each of the sleeve section and of the plurality of hollow tubes is enabled to receive at least one vertical extension mean for coupling a cover member to cover a cargo loaded onto the ATV; and
c. at least one rack member enabled to get coupled to at least one vertical extension mean parallel to the cargo rack coupled at a back of the ATV.
